(19) United States
(12) Patent Application Publication
(10) Pub. No.: US 2005/0058279 A1
(43) Pub. Date: Mar. 17, 2005

(54) Power supply signal from system side circuit to line side circuit in telecommunication device

(76) Inventors: Scott Chiu, Folsom, CA (US); Richard Carruth, Tempe, AZ (US)

Correspondence Address: BUCKLEY, MASCHOFF, TALWALKAR LLC, 5 ELM STREET, NEW CANAAN, CT, 06840, US

(21) Appl. No.: 10/664,334

(22) Filed: Sep. 17, 2003

(51) Int. Cl. H04M 1/00; H04M 9/00

(52) U.S. Cl. 379/412; 379/399.01

(57) ABSTRACT

In some embodiments, an apparatus includes a line side circuit and a system side circuit to couple to the line side circuit via an isolation interface. The system side circuit includes a first clock line to couple to the line side circuit via a first capacitor to supply a first clock signal to the line side circuit, and a second clock line to couple to the line side circuit via a second capacitor to supply a second clock signal to the line side circuit.

### BACKGROUND

Items of telecommunication equipment such as data modems typically include an isolation interface between most of the circuitry of the equipment and the line interface. The purpose of the isolation interface is to aid in preventing damage to the equipment from large transients that may occur on a subscriber line to which the equipment may be connected. The equipment may include a line side integrated circuit (IC) on the line side of the isolation interface. The line side IC may monitor loop conditions such as on- or off-hook status and/or may receive an FM signal that provides caller ID information. The equipment may also include a system side IC on the system (customer premise) side of the isolation interface. The system side IC may perform functions such as signal modulation/demodulation, digital signal processing, and various housekeeping functions.

When the telecommunication equipment is in an on-hook condition, little power is available from the central office for the line side IC. Therefore, power for the line side IC is typically provided via a clock signal from the system side IC that is capacitively or transformer coupled to the line side IC power supply. To provide a substantially stable power signal at the line side IC, the clock signal is typically subjected to very substantial filtering by a complex and rather large filter that is coupled between the line side IC power connection to the isolation interface and the line side IC power supply. The power signal filter of the line side IC may contribute significantly to the size and complexity of the line side IC.

### BRIEF DESCRIPTION OF THE DRAWINGS

FIG. 1 is a high level block diagram which shows a data modem connected to a telephone central office via a telephone subscriber line.

FIG. 2 is a block diagram that illustrates the modem shown in FIG. 1.

FIG. 3 is a schematic circuit diagram that shows power-related portions of system side and line side IC's that are part of the modem of FIG. 2.

FIG. 4 is a waveform diagram that illustrates clock signals that are supplied from the system side IC to the line side IC to provide power for the line side IC.

### DETAILED DESCRIPTION

FIG. 1 is a high level block diagram that shows a modem 10 provided according to some embodiments. The modem 10 is coupled via a telephone subscriber line 12 to a telephone central office 14.

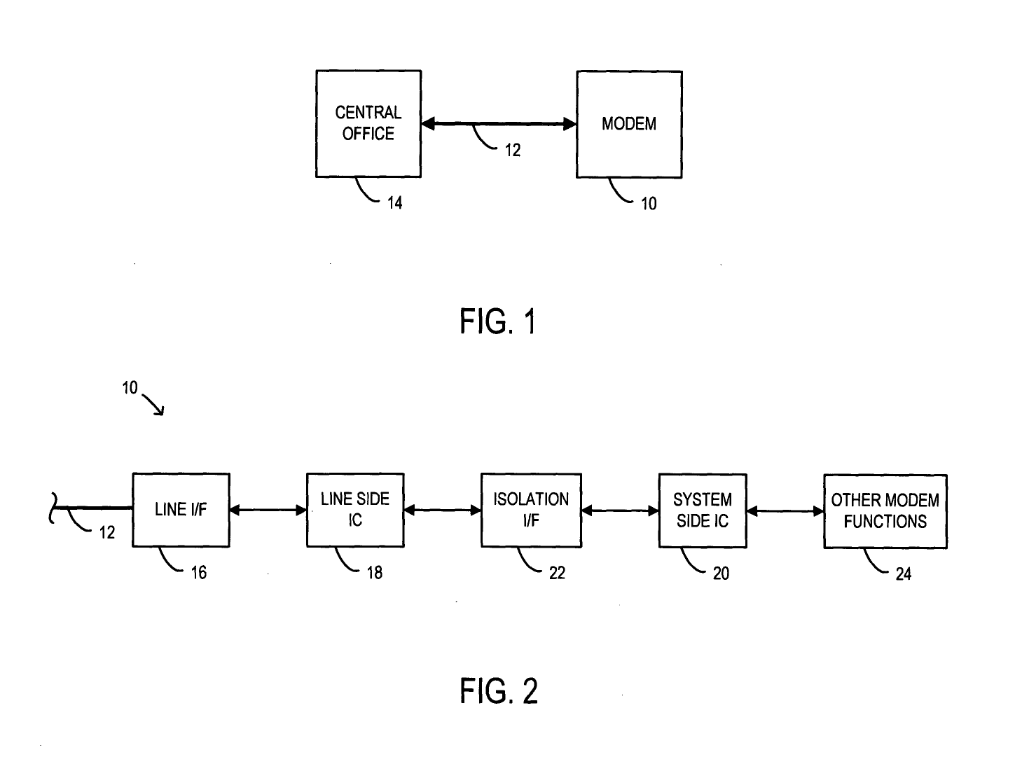

FIG. 2 is a block diagram that shows some details of the modem 10. The modem 10 includes a line interface 16 coupled to the telephone subscriber line 12. The modem also includes a line side IC 18 coupled to the line interface 16. Also included in the modem 10 is a system side IC 20 coupled to the line side IC 18 via an isolation interface 22 that is also part of the modem 10. Circuitry and components for performing other functions of the modem 10 are schematically represented by block 24 in FIG. 2.

The line interface 16 may be provided in accordance with typical practices to allow the modem 10 to be coupled to the telephone subscriber line 12.

The line side IC 18 may perform typical functions of a line side circuit, including monitoring line conditions such as on-hook or off-hook status. The line side IC 18 may also receive an FM signal provided for purposes of caller identification. Other functions may also be performed by the line side IC. There will be described below an arrangement provided in accordance with some embodiments by which the line side IC 18 is powered from signals supplied by the system side IC 20.

The isolation interface 22 provides isolation of the system side IC from transient signals that may be present on the subscriber line 12. In particular, the isolation interface 22 may be formed of a number of capacitive coupling connections between the line side IC 18 and the system side IC 20.

The system side IC 20 may perform typical functions of a system side circuit, including signal modulation and demodulation, signal processing, and various housekeeping functions. There will be described below an arrangement provided in accordance with some embodiments by which the system side IC 20 supplies power to the line side IC 18.

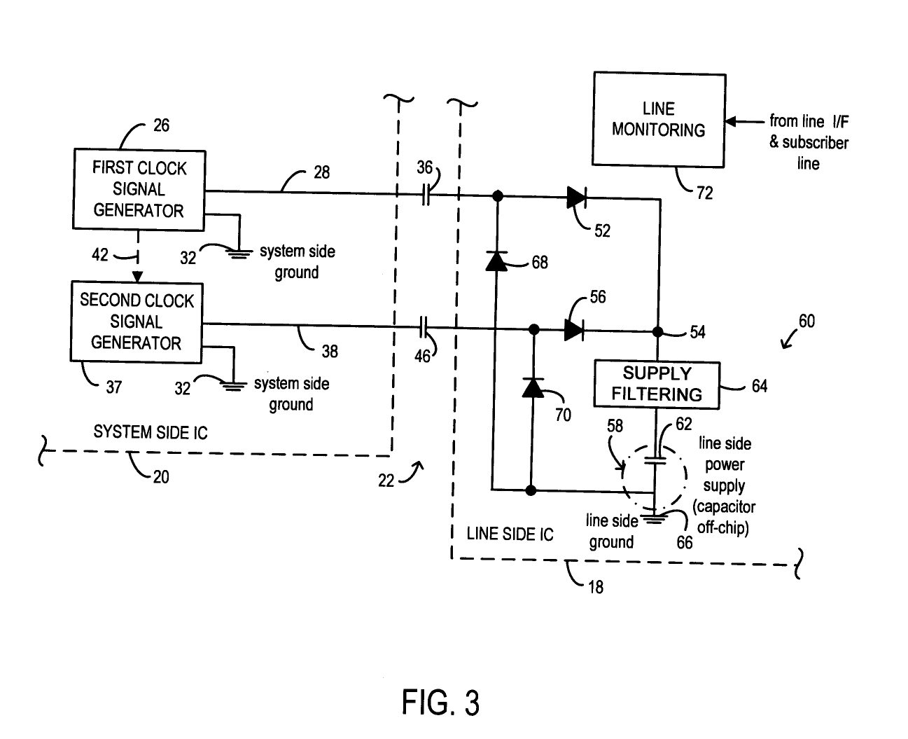

FIG. 3 is a schematic circuit diagram that shows portions of the system side IC 20 and the line side IC 18 that are concerned with providing power to the line side IC 18 in accordance with some embodiments.

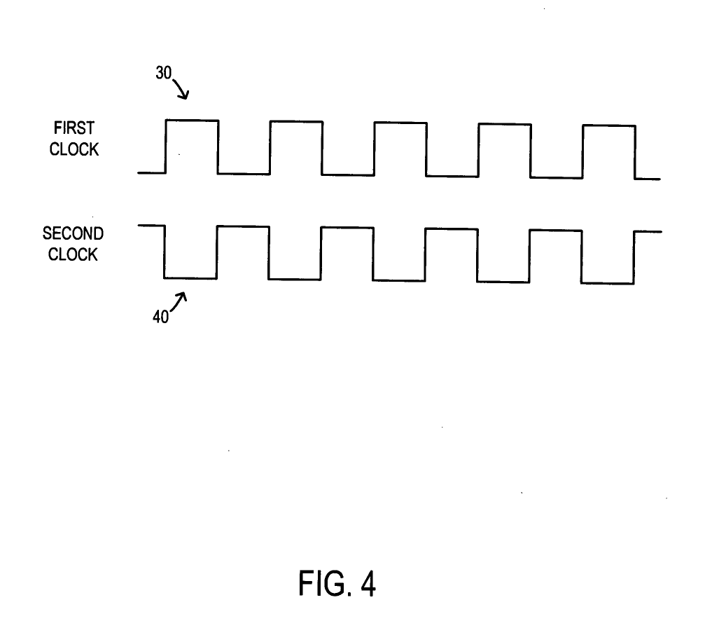

The system side IC 20 includes a first clock signal generator 26 and a first clock line 28. The first clock signal generator 26 supplies a first clock signal on the first clock line 28. An example of the first clock signal is illustrated by the waveform 30 shown in FIG. 4, and may be a square wave having substantially a 50% duty cycle. In some embodiments, the first clock signal may have an amplitude of 3.3 V, for example. In this example, the first clock signal may swing from substantially 0 V (off) to substantially 3.3 V (on). The first clock signal generator 26 may be referenced to system side ground 32.

The first clock line 28 is coupled to a first capacitor 36 that is part of the isolation interface 22 between the system side IC 20 and the line side IC 18. The capacitor 36 may be provided “off-chip”; that is, the capacitor 36 may be separate from both the system side IC 20 and the line side IC 18.

The system side IC 20 also includes a second clock signal generator 37 and a second clock line 38. The second clock signal generator 37 supplies a second clock signal on the second clock line 38. An example of the second clock signal is illustrated by the waveform 40 shown in FIG. 4. It will be observed that, in this example, the second clock signal 40 is a square wave that is substantially 180° out of phase with the first clock signal 30 and that has the same amplitude as the first clock signal 30. For example, if the first clock signal has an amplitude of 3.3 V, the amplitude of the second clock signal may also be 3.3 V. In this example, the second clock signal may swing from substantially 0 V (off) to substantially 3.3 V (on), and the second clock signal may be at substantially 0 V at times when the first clock signal is at substantially 3.3 V, and the second clock signal may be at substantially 3.3 V when the first clock signal is at substantially 0 V.

In some embodiments, the second clock signal generator 37 may generate the second clock signal on the basis of the first clock signal. For this purpose the first clock signal may be provided from the first clock signal generator 26 to the second clock signal generator 37, as indicated at 42. For example, the second clock signal generator 37 may function as an inverter with respect to the first clock signal. The second clock signal generator 37 may be referenced to system side ground 32.

The second clock line 38 is coupled to a second capacitor 46 that is part of the isolation interface 22 between the system side IC 20 and the line side IC 18. The capacitor 46 may be provided “off-chip”; that is, the capacitor 46 may be separate from both the system side IC 20 and the line side IC 18.

The line side IC 18 includes a first clock receive line 48 to receive the first clock signal 30. The first clock receive line 48 is coupled to the first capacitor 36 such that the first capacitor 36 couples the first clock line 28 to the first clock receive line 48 so that the first clock line 28 supplies the first clock signal to the line side IC 18.

The line side IC 18 also includes a second clock receive line 50 to receive the second clock signal 40. The second clock receive line 50 is coupled to the second capacitor 46 such that the second capacitor 46 couples the second clock line 38 to the second clock receive line 50 so that the second clock line 38 supplies the second clock signal to the line side IC 18.

The line side IC 18 further includes a first diode 52 that couples the first clock receive line 48 to a node 54. The polarity of the diode 52 is such that current may flow from the first clock receive line 48 to the node 54.

Also included in the line side IC 18 is a second diode 56 that couples the second clock receive line 50 to the node 54. The polarity of the diode 56 is such that current may flow from the second clock receive line 50 to the node 54.

A line side power supply, generally indicated by reference numeral 58, is associated with the line side IC 18, and may be considered to be part of a line side circuit 60 that also includes the line side IC 18. The line side power supply 58 includes a third capacitor 62 that is coupled to the node 54 via a supply filtering circuit 64. The capacitor 62 may be provided off-chip (i.e., not as part of the line side IC 18). The two clock signals received on clock receive lines 48 and 50 are effectively combined at the node 54 to form a substantially constant power signal level that is filtered at the supply filtering circuit 64 and which charges the capacitor 62 to provide a substantially smooth power signal level for the line side IC 18. Because a substantially constant signal level, with minimal ripple, is provided at the node 54, the supply filtering circuit 64 may be much smaller and less complex than a supply filtering circuit included in a conventional line side IC.

The power supply capacitor 62 may be coupled to the line side ground 66, which need not be at the same level as the system side ground 32 for the system side IC 20. The line side IC 18 also includes diodes 68, 70 which are respectively coupled between the system side ground 66 and the first clock receive line 48 and between the system side ground 66 and the second clock receive line 50.

The line side IC 18 also includes line monitoring circuitry 72 which may be coupled to the subscriber line 12 (FIG. 2) via the line interface 16. The line monitoring circuitry 72 may be provided in accordance with conventional principles to monitor one or more conditions of the subscriber line. Power for the line monitoring circuitry 72 may be provided from the line side power supply 58, but to simplify the drawing, no connection is shown between the line side power supply 58 and the line monitoring circuitry 72. One skilled in the art will appreciate how to connect monitoring circuitry 72 and power supply 58 without undue experimentation. Also omitted for the same reason are signaling connections, such as line status signaling connections. It should also be understood that the isolation interface 22 may include one or more additional capacitors (not shown) in addition to capacitors 36 and 46 to provide capacitive coupling with isolation for one or more signaling paths between components of the system side IC 20 and the line side IC 18. Such components, except for the line monitoring circuitry 72, although present, are not shown to simplify the drawing.

In operation, the first clock signal generator 26 of the system side IC 20 generates the first clock signal 30 shown in FIG. 4. The first clock signal 30 is supplied from the system side IC 20 to the line side IC 18 via the first capacitor 36. The second clock signal generator 37 of the system side IC 20 generates the second clock signal 40 shown in FIG. 4. This may be done, for example, on the basis of the first clock signal 30 which may be supplied from the first clock signal generator 36 to the second clock signal generator 37. The second clock signal 40 is supplied from the system side IC 20 to the line side IC 18 via the second capacitor 46. The first and second clock signals, respectively received on the first clock receive line 48 and the second clock receive line 50, are combined at the node 54 of the line side IC 18 to form a substantially constant power signal for the line side circuit 60 (including the line side IC 18). The matching of the on and off phases of the two clock signals is of course not ideal, so that there is a degree of “ripple” in the signal at node 54. Filtering to attenuate the “ripple” is provided by the supply filtering circuitry 64. However, residual harmonics of the clock frequency that are present in the signal at node 54 may be lower in power and higher in frequency than the harmonic signals resulting from conventional clock signal power transmission across an isolation interface when only one clock signal is used. In some simulated results the ripple amplitude may be reduced by a factor of four or five in comparison to conventional half-wave rectification for power transmission. Accordingly, the supply filtering circuitry 64 provided according to some embodiments may be substantially smaller and less complex than conventional supply filtering circuitry that may be used in line side IC's. This may allow for reduction in cost of the supply filtering circuitry, and thus reduction in cost of the line side IC. In some embodiments, the ripple amplitude may be reduced by reducing the rise/fall times of the first and second clock signals, to reduce the frequency components of the first and second clock signals that are not exactly out of phase.

In the example clock signals illustrated in FIG. 4, a 50% duty cycle is employed. However this is not required. For example, the first clock signal may have a 60% duty cycle and the second clock signal may have a 40% duty cycle. Whatever duty cycle is employed, the “on” periods of the first clock signal should be matched in time to the “off’ periods of the second clock signal, and the “off’ periods of the first clock signal should be matched in time to the “on” periods of the second clock signal. More generally, a differential clock signal may be used as the first and second clock signals.

As an alternative to employing a line side IC, a line side circuit formed of discrete components may be used. Alternatively, or in addition, the system side IC may be replaced with circuitry formed of discrete components.

The above illustrated arrangement for transmitting power from a system side circuit to a line side circuit has been shown in the context of a modem, but may alternatively be employed in other types of telephone customer premise equipment, including, for example, telephones, fax machines, and telephone answering machines.

The several embodiments described herein are solely for the purpose of illustration. The various features described herein need not all be used together, and any one or more of those features may be incorporated in a single embodiment. Therefore, persons skilled in the art will recognize from this description that other embodiments may be practiced with various modifications and alterations.

1. An apparatus comprising:
a line side circuit; and
a system side circuit to couple to the line side circuit via an isolation interface;
the system side circuit including:
a first clock signal generator to supply a first clock signal to the line side circuit via the isolation interface; and
a second clock signal generator to supply a second clock signal to the line side circuit via the isolation interface;
wherein the first and second clock signals when added sum to a signal having a substantially constant voltage.

2. The apparatus of claim 1, wherein the second clock signal is out of phase with the first clock signal.

3. The apparatus of claim 2, wherein each of the first and second clock signals has a substantially 50% duty cycle, and the first and second clock signals are substantially 180° out of phase with each other.

4. The apparatus of claim 1, wherein the first clock signal has substantially less than a 50% duty cycle and the second clock signal has substantially more than a 50% duty cycle.

5. The apparatus of claim 1, further comprising:
a first capacitor to couple the first clock signal to the line side circuit; and
a second capacitor to couple the second clock signal to the line side circuit.

6. The apparatus of claim 5, wherein the line side circuit includes:
a line side power supply;
a first diode to couple between the first capacitor and the line side power supply; and
a second diode to couple between the second capacitor and the line side power supply.

7. The apparatus of claim 6, wherein the line side power supply includes a third capacitor.

8. The apparatus of claim 7, wherein the line side circuit includes line monitoring circuitry to monitor at least one condition of a telephone subscriber line.

9. A chip set comprising:
a first integrated circuit (IC); and
a second IC;
the second IC including a first clock signal generator to supply a first clock signal to the first IC and a second clock signal generator to supply a second clock signal to the first IC;
the first IC including a first clock receive line to receive the first clock signal and a second clock receive line to receive the second clock signal;
wherein the first and second clock signals when added sum to a signal having a substantially constant voltage.

10. The chip set of claim 9, wherein the second clock signal is out of phase with the first clock signal.

11. The chip set of claim 10, wherein each of the first and second clock signals has a substantially 50% duty cycle, and the first and second clock signals are substantially 180° out of phase with each other.

12. The chip set of claim 9, wherein the first clock signal has substantially less than a 50% duty cycle and the second clock signal has substantially more than a 50% duty cycle.

13. The chip set of claim 9, wherein the first IC further includes:
a first diode to couple the first clock receive line to a power supply of the first IC; and
a second diode to couple the second clock receive line to the power supply of the first IC.

14. The chip set of claim 13, wherein the first IC includes line monitoring circuitry to monitor at least one condition of a telephone subscriber line.

15. A method comprising:
supplying a first clock signal from a system side circuit to a line side circuit via an isolation interface; and
supplying a second clock signal from the system side circuit to the line side circuit via the isolation interface;
wherein the first and second clock signals when added sum to a signal having a substantially constant voltage.

16. The method of claim 15, further comprising:
combining the first and second clock signals at the line side circuit to produce a substantially constant power signal for the line side circuit.

17. The method of claim 16, wherein the second clock signal is out of phase with the first clock signal.

18. The method of claim 15, wherein:
the first clock signal is supplied to the line side circuit via a first capacitor; and
the second clock signal is supplied to the line side circuit via a second capacitor.

19. A system comprising:
a line interface to couple to a telephone subscriber line;
a first circuit coupled to the line interface; and
a second circuit that is coupled to the first circuit via an isolation interface;
the second circuit including:
a first clock signal generator to supply a first clock signal to the first circuit via the isolation interface; and
a second clock signal generator to supply a second clock signal to the first circuit via the isolation interface;
wherein the first and second clock signals when added sum to a signal having a substantially constant voltage.

20. The system of claim 19, wherein the second clock signal is out of phase with the first clock signal.

21. The system of claim 20, wherein each of the first and second clock signals has a substantially 50% duty cycle, and the first and second clock signals are substantially 180° out of phase with each other.

22. The system of claim 19, wherein the first clock signal has substantially less than a 50% duty cycle and the second clock signal has substantially more than a 50% duty cycle.

23. The system of claim 19, further comprising:
a first capacitor to couple the first clock signal to the first circuit; and
a second capacitor to couple the second clock signal to the first circuit.

24. The system of claim 23, wherein the first circuit includes:
a power supply;
a first diode coupled between the first capacitor and the power supply; and
a second diode coupled between the second capacitor and the power supply.

25. The system of claim 24, wherein the power supply includes a third capacitor.

26. The system of claim 25, wherein the first circuit includes line monitoring circuitry to monitor at least one condition of a telephone subscriber line.
